(19) United States
(12) Patent Application Publication
(10) Pub. No.: US 2022/0070325 A1
(43) Pub. Date: Mar. 3, 2022

(54) INFORMATION PROCESSING APPARATUS

(71) Applicant: FUJIFILM BUSINESS INNOVATION CORP., Tokyo (JP)

(72) Inventors: Shusaku KUBO, Kanagawa (JP); Junichi SHIMIZU, Kanagawa (JP); Kosuke TOMOKUNI, Kanagawa (JP); Mamiko SATO, Kanagawa (JP)

(73) Assignee: FUJIFILM BUSINESS INNOVATION CORP., Tokyo (JP)

(21) Appl. No.: 17/177,450

(22) Filed: Feb. 17, 2021

(30) Foreign Application Priority Data
Sep. 2, 2020 (JP) 2020-147522

(51) Int. Cl. H04N 1/00

(52) U.S. Cl. CPC H04N 1/00949; H04N 1/00435; H04N 2201/0094; H04N 1/00424; H04N 1/00458

(57) ABSTRACT

An information processing apparatus includes a processor configured to: evaluate the performance of each of plural combinations of processes, each combination including a series of processes, the plural combinations being included in plural processes, the series of processes being configured to be performed on an image, the performance being evaluated on the basis of the result of performing the series of processes on a test image for each combination; select a combination of processes, the evaluated performance of which meets a first selection condition, from among the plural combinations of processes, and process an actual image; and in the case where a performance obtained by processing the actual image meets a switch condition determined in advance, switch to a combination of processes, the evaluated performance of which meets a second selection condition, and process the actual image.

### CROSS-REFERENCE TO RELATED APPLICATIONS

This application is based on and claims priority under 35 USC 119 from Japanese Patent Application No. 2020-147522 filed Sep. 2, 2020.

### BACKGROUND

### (i) Technical Field

The present disclosure relates to an information processing apparatus.

### (ii) Related Art

Japanese Unexamined Patent Application Publication No. 2017-41222 describes a technique of storing information about a first process and information about a second process in association with each other and executing the second process on electronic data when an error occurs in the first process performed using the electronic data.

### SUMMARY

Services to perform processing on images such as character recognition, translation, and printing have been provided from various business operators in recent years, and there are an increasing number of cases where a plurality of processes are used in combination with each other. A user desires to use a combination of processes with high performance continuously as long as possible. When some problem occurs, however, the performance of the processes, which was high at the first of use, may be lowered to delay the processes, etc.

Aspects of non-limiting embodiments of the present disclosure relate to suppressing a reduction in the performance of processes caused when a problem occurs in the case where a plurality of processes are used on an image in combination with each other.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to evaluate a performance of each of a plurality of combinations of processes, each combination including a series of processes, the plurality of combinations being included in a plurality of processes, the series of processes being configured to be performed on an image, the performance being evaluated on a basis of a result of performing the series of processes on a test image for each combination, select a combination of processes, the evaluated performance of which meets a first selection condition, from among the plurality of combinations of processes, and process an actual image, and in a case where a performance obtained by processing the actual image meets a switch condition determined in advance, switch to a combination of processes, the evaluated performance of which meets a second selection condition, and process the actual image.

### BRIEF DESCRIPTION OF THE DRAWINGS

An exemplary embodiment of the present disclosure will be described in detail based on the following figures, wherein:

FIG. 1 illustrates the overall configuration of an information processing system according to an exemplary embodiment;

FIG. 2 illustrates the hardware configuration of an image processing apparatus;

FIG. 3 illustrates the hardware configuration of an external apparatus;

FIG. 4 illustrates the functional configuration implemented by the information processing system;

FIG. 5 illustrates an example of a displayed operation screen;

FIGS. 6A and 6B illustrate examples of a displayed order image;

FIG. 7 illustrates an example of evaluation result information; and

FIG. 8 illustrates an example of operation procedures in a switching process.

### DETAILED DESCRIPTION

### [1] Exemplary Embodiment

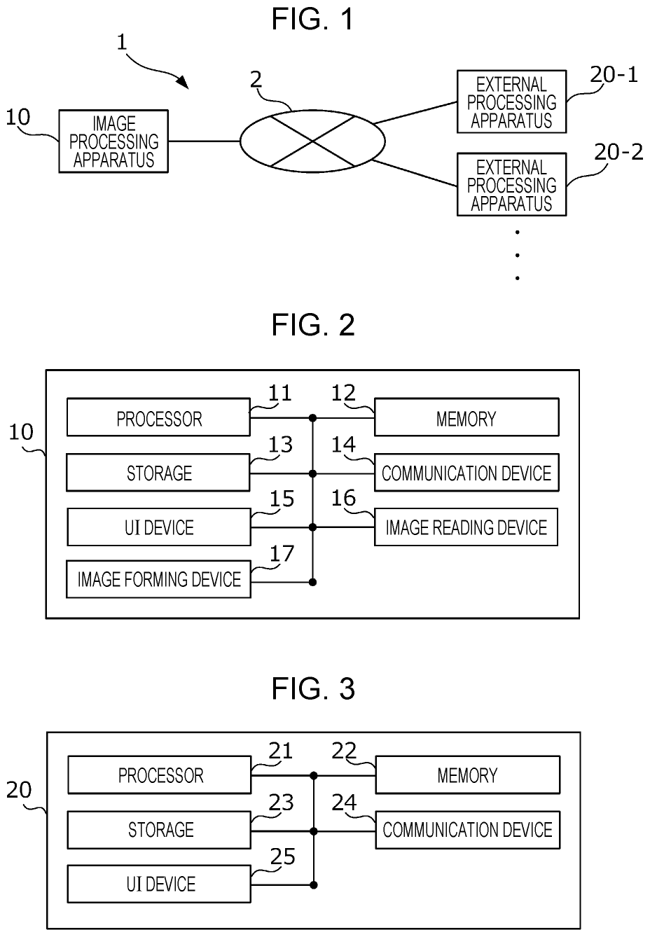

FIG. 1 illustrates the overall configuration of an information processing system 1 according to an exemplary embodiment. The information processing system 1 is a system that processes various types of information. The information processing system 1 includes a communication line 2, an image processing apparatus 10, and a plurality of external processing apparatuses 20-1, 20-2, . . . (which will be referred to as “external processing apparatuses 20” if not differentiated from each other).

The communication line 2 is a communication system that includes a mobile communication network, the Internet, etc., and relays exchange of data between devices (such as devices, terminals, and systems) that communicate with the system. The image processing apparatus 10 and the external processing apparatuses 20 are connected to the communication line 2 through wired communication. The communication between the devices and the communication line 2 is not limited to that in the example illustrated in FIG. 1, and may be either wired communication or wireless communication.

The image processing apparatus 10 and the external processing apparatuses 20 are all devices that perform information processing (hereinafter referred to “image processing”) related to images. The image processing apparatus 10 performs image processing such as printing, copying, scanning, and faxing. The external processing apparatuses 20 perform image processing such as character recognition, translation, object recognition, and conversion between image file formats. The image processing executed by the plurality of external processing apparatuses 20 includes mutually overlapping processes. For example, both the external processing apparatuses 20-1 and 20-2 execute translation processes.

A user who uses the information processing system 1 executes a series of image processing using at least one of the image processing apparatus 10 and the image processing apparatuses 20. For example, the user causes an image processing apparatus 10 to execute a process of scanning a document. Next, the user causes the external processing apparatus 20 to execute a process of recognizing characters in the digitalized document image, and causes a different external processing apparatus 20 to execute a process of translating the recognized characters.

As discussed above, some image processing is executable by a plurality of devices, and the performance of the image processing is varied among the devices. The information processing system 1 evaluates the performance of image processing performed by the devices. The method of evaluating the performance will be described in detail later.

FIG. 2 illustrates the hardware configuration of the image processing apparatus 10. The image processing apparatus 10 is a computer that includes a processor 11, a memory 12, a storage 13, a communication device 14, a user interface (UI) device 15, an image reading device 16, and an image forming device 17. The processor 11 includes a computation device such as a central processing unit (CPU), a resistor, a peripheral circuit, etc., for example. The memory 12 is a storage medium that is readable by the processor 11, and includes a random access memory (RAM), a read only memory (ROM), etc.

The storage 13 is a storage medium that is readable by the processor 11, and includes a hard disk drive, a flash memory, etc., for example. The processor 11 controls operation of various hardware components by executing a program stored in the ROM or the storage 13 using the RAM as a work area. The communication device 14 is a communication unit that includes an antenna, a communication circuit, etc. and performs communication via the communication line 2.

The UI device 15 is an interface to be provided to the user who uses the image processing apparatus 10. The UI device 15 includes a touch screen that includes a display as a display unit and a touch panel provided on the surface of the display, for example, and displays an image and receives an operation from the user. The UI device 15 may also include an operator such as a keyboard, besides the touch screen, and receives an operation on the operator.

The image reading device 16 is hardware (a so-called “scanner”) that reads an image depicted on a medium such as paper, and is an image reading unit that reads an image from a medium set on the image processing apparatus 10. The image forming device 17 is a so-called printer that forms an image on a medium such as paper, and is an image forming unit that forms an image on a medium set on the image processing apparatus 10 by transferring and fixing the image using an electrophotographic system while transporting the medium.

The image reading device 16 and the image forming device 17 are not necessary components, and may not be provided in the image processing apparatus 10. In such a case, the image processing apparatus 10 may perform image processing by transmitting and receiving image data to and from an external image reading device 16 and/or an external image forming device 17.

FIG. 3 illustrates the hardware configuration of the external processing apparatus 20. The external processing apparatus 20 is a computer that includes a processor 21, a memory 22, a storage 23, a communication device 24, and a UI device 25. The processor 21 to the UI device 25 are hardware components that are similar to the processor 11 to the UI device 15 illustrated in FIG. 2.

In the information processing system 1, the processors of the apparatuses described above control the various sections by executing the programs to implement the functions discussed below. Operation performed by each function is depicted also as operation performed by the processor of the apparatus which implements the function.

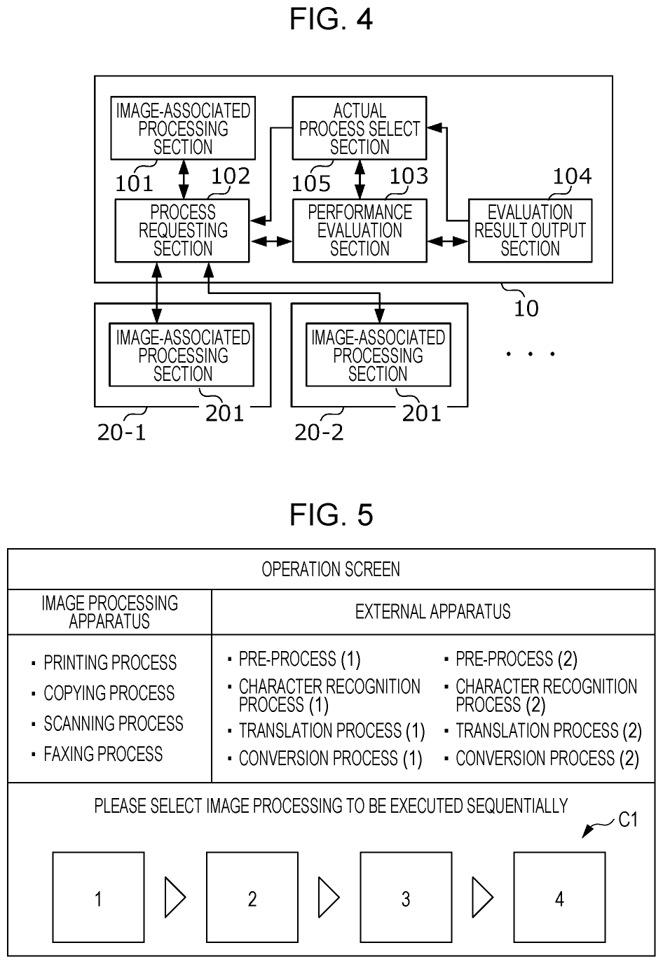

FIG. 4 illustrates the functional configuration implemented by the information processing system 1. The image processing apparatus 10 includes an image-associated processing section 101, a process requesting section 102, a performance evaluation section 103, an evaluation result output section 104, and an actual process select section 105. The external processing apparatuses 20 each include an image-associated processing section 201.

The image-associated processing section 101 of the image processing apparatus 10 executes various image processing such as the printing process discussed above. The image-associated processing section 201 of the external processing apparatus 20 executes various image processing such as the character recognition process discussed above. The process requesting section 102 of the image processing apparatus 10 requests the function of executing image processing to execute image processing requested from the user. The process requesting section 102 displays an operation screen for receiving an operation by the user.

FIG. 5 illustrates an example of the displayed operation screen. In the example in FIG. 5, the process requesting section 102 displays a list of image processes that are executable by the image processing apparatus 10 and a list of image processes that are executable by the external processing apparatus 20. In the case where the same image processing is executable by a plurality of devices, the process requesting section 102 identifies the processes by affixing numbers assigned to the devices, as with “character recognition process (1)” and “character recognition process (2)” in the drawing.

In addition, the process requesting section 102 displays a character string saying “Please select image processing to be executed sequentially.” and an order image C1 that indicates the order of image processing to be executed. On this operation screen, the user drags image processing that he/she desires to execute from an image processing menu, and drops the image processing on the order image C1. When the above operation is performed, the process requesting section 102 displays the dropped image processing on the order image C1.

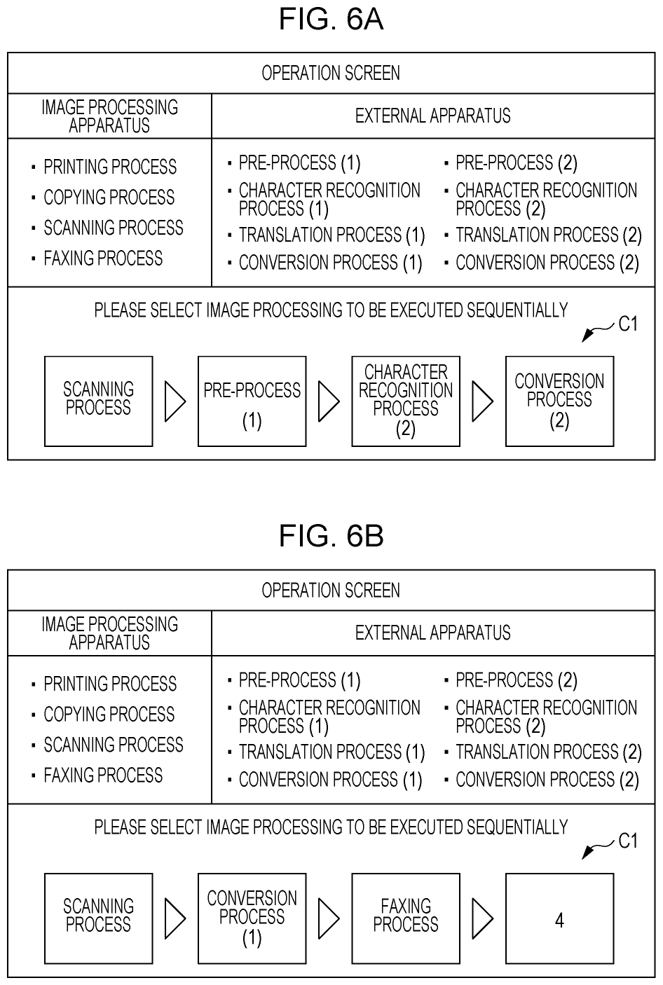

FIG. 6 illustrates an example of the displayed order image C1. In the example in FIG. 6A, image processing is selected such that a “scan process” is executed in the first order, a “pre-process (1)” is executed in the second order, a “character recognition process (2)” is executed in the third order, and a “conversion process (2)” is executed in the fourth order. In the example in FIG. 6B, image processing is selected such that a “scan process” is executed in the first order, a “conversion process (1)” is executed in the second order, and a “facsimile process” is executed in the third order.

While the number of the series of processes is three or four in the examples in FIGS. 6A and 6B, the number of the series of processes may be two or five or more. When an operation to press an execution button (not illustrated) is performed, the process requesting section 102 requests the image-associated processing sections (image-associated processing section 101 and image-associated processing section 201) to execute the selected image processing.

The performance evaluation section 103 evaluates the performance of the processes included in each combination of the series of processes to be performed on an image on the basis of the result of performing the processes on a test image for each combination. The combination of the series of processes corresponds to a combination including the “scan process”, the “pre-process (1)”, the “character recognition process (2)”, and the “conversion process (2)” in the example in FIG. 6A, and corresponds to a combination including the “scan process”, the “conversion process (1)”, and the “facsimile process” in the example in FIG. 6B, for example.

Performance evaluation by the performance evaluation section 103 is performed in advance before the user starts to use the information processing system 1. Performance evaluation may also be performed after the start of use, when a new function has been added. The performance evaluation section 103 evaluates performance in the case where an evaluation operation for evaluating the performance of a process has been performed. The evaluation operation may be an operation to determine a combination of a series of processes and an operation to designate a test image, for example.

The operation to determine a combination of a series of processes is performed as in the examples in FIGS. 6A and 6B. The operation to designate a test image is an operation to update a test image file prepared in advance to the image processing apparatus 10. In the case where the scan process is included, an operation to scan paper on which a test image has been printed is performed as the operation to designate a test image.

When an evaluation operation is performed, the performance evaluation section 103 requests the process requesting section 102 to perform the series of processes determined through the evaluation operation for the test image designated through the evaluation operation. The process requesting section 102 requests the image-associated processing sections (image-associated processing section 101 and image-associated processing section 201) to perform the processes on the test image as requested. The image-associated processing sections execute the processes on the test image in accordance with the received request.

When the processes on the test image are executed, the image-associated processing sections supply the performance evaluation section 103 with result information that indicates the result of the executed processes. Examples of the result information include the time required for the processes, the size of the memory used for the processes, the certainty of recognized characters (in the case of the character recognition process), and the use fee. The performance evaluation section 103 evaluates the performance of the processes included in each combination discussed above on the basis of the supplied result information.

The performance evaluation section 103 prepares evaluation result information in which combinations of the series of processes and orders of the performance are correlated with each other, for example.

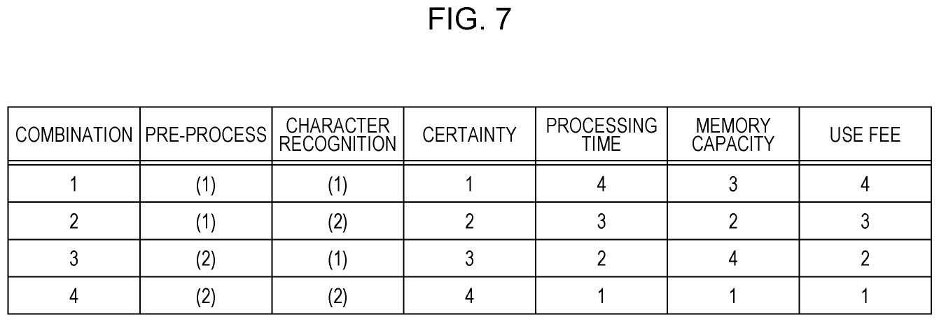

FIG. 7 illustrates an example of the evaluation result information. In the example in FIG. 7, four combinations of the pre-process and the character recognition process (combination 1=(1) and (1), combination 2=(1) and (2), combination 3=(2) and (1), and combination 4=(2) and (2)) and orders of the performance are correlated with each other.

Combination 1 is in the first place for the certainty, the fourth place for the processing time and the use fee, and the third place for the memory capacity. Combination 2 is in the second place for the certainty and the memory capacity, and the third place for the processing time and the use fee. Combination 3 is in the second place for the processing time and the use fee, the third place for the certainty, and the fourth place for the memory capacity. Combination 4 is in the fourth place for the certainty, and the first place for the processing time, the memory capacity, and the use fee. The performance evaluation section 103 supplies the prepared evaluation result information to the evaluation result output section 104.

The evaluation result output section 104 outputs the result of evaluation for at least two combinations of the series of processes on the basis of the supplied evaluation result information. The evaluation result output section 104 outputs the evaluation result to the actual process select section 105. The actual process select section 105 selects a combination of processes, the evaluated performance of which meets a first selection condition determined in advance, from among a plurality of combinations of processes on the basis of the output evaluation result.

The actual process select section 105 determines that a combination of processes, the average rank of which is the highest, meets the first selection condition in the case where the result of evaluating the performance of the processes is represented in ranks as in FIG. 7, for example. In the example in FIG. 7, the average ranks for Combinations 1, 2, 3, and 4 are (1+4+3+4)/4=3, (2+3+2+3)/4=2.5, (3+2+4+2)/4=2.75, and (1+4+3+4)/4=1.75, respectively, and thus the actual process select section 105 determines that Combination 4 meets the first selection condition. The actual process select section 105 may determine average ranks with a weight given to each type of the performance.

The actual process select section 105 selects a combination determined to meet the first selection condition, and supplies the selected combination to the process requesting section 102. The process requesting section 102 requests the image-associated processing sections to execute the series of processes indicated by the supplied combination. The image-associated processing sections process the actual image through the requested series of processes, that is, the processes in the combination selected by the actual process select section 105.

When the processes on the actual image are executed, the image-associated processing sections supply the performance evaluation section 103 with result information that indicates the result of the executed processes. The performance evaluation section 103 evaluates the performance of processes included in each combination on the basis of the supplied result information on the actual process as in the exemplary embodiment. The performance evaluation section 103 prepares evaluation result information that indicates the evaluation result with the actual image, and supplies the evaluation result information to the evaluation result output section 104.

The evaluation result output section 104 determines whether or not the performance obtained by processing the actual image meets a switch condition determined in advance. In the present exemplary embodiment, the evaluation result output section 104 determines that the switch condition is met in the case where the performance obtained by processing the actual image does not meet a determined criterion. The evaluation result output section 104 determines a threshold for the processing time of each process as the criterion, and determines that the process performance does not reach the criterion and the switch condition is met for processes, the processing time of which for processing the actual image is equal to or more than the threshold, for example.

In the case where it is determined that the switch condition is met, the evaluation result output section 104 notifies the performance evaluation section 103 accordingly. In the case where this notification is received, that is, in the case where the switch condition is met, the performance evaluation section 103 re-evaluates the performance using the test image. The evaluation result output section 104 outputs the result of the re-evaluation to the actual process select section 105. The actual process select section 105 selects a combination of processes, the evaluated performance of which meets a second selection condition determined in advance, from among the plurality of combinations of processes on the basis of the output evaluation result.

The second selection condition is a condition to be met by a combination of processes that is different from the combination of processes that meets the first selection condition. The actual process select section 105 determines that a combination of processes, the average rank of which is the second highest, meets the second selection condition in the case where the result of evaluating the performance of the processes is represented in ranks as in FIG. 7, for example. In the example in FIG. 7, the actual process select section 105 selects Combination 2, the average rank of which is the second highest, as the combination to execute the actual process.

The process requesting section 102 requests the image-associated processing sections to execute the series of processes indicated by the combination selected by the actual process select section 105. The image-associated processing sections process the actual image through the requested series of processes, that is, the processes in the combination that meets the second selection condition.

In this manner, in the case where the performance obtained by processing the actual image meets the switch condition, the image-associated processing sections switch to the combination of processes, the evaluated performance of which meets the second selection condition, and process the actual image. In the case where the switch condition is met, in addition, the image-associated processing sections switch to the combination of processes, the performance of which meets the second selection condition, after re-evaluating the performance using the test image.

The image processing apparatus 10 which is configured as described above evaluates the performance of a series of processes, and performs the switching process for switching the combination of processes in the case where the evaluated performance is not achieved in the actual process.

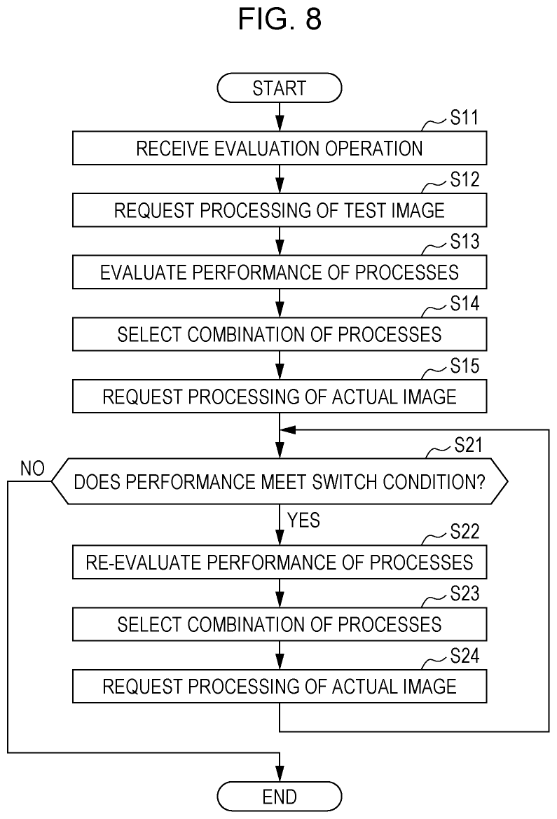

FIG. 8 illustrates an example of operation procedures in the switching process. First, the image processing apparatus 10 (performance evaluation section 103) receives an evaluation operation for evaluating the performance of processes (an operation to determine a combination of a series of processes and an operation to designate a test image) (step S11).

Next, the image processing apparatus 10 (process requesting section 102) requests the image-associated processing sections to perform the series of processes determined through the evaluation operation on the test image designated through the evaluation operation (step S12). Subsequently, the image processing apparatus 10 (performance evaluation section 103) evaluates the performance of the processes included in each combination of the series of processes to be performed on an image on the basis of the result of performing the processes on a test image for each combination (step S13).

Next, the image processing apparatus 10 (actual process select section 105) selects a combination of processes, the evaluated performance of which meets the first selection condition determined in advance, from among a plurality of combinations of processes on the basis of the output evaluation result (step S14). Subsequently, the image processing apparatus 10 (process requesting section 102) requests the image-associated processing sections to execute the series of processes indicated in the selected combination (step S15).

Next, the image processing apparatus 10 (evaluation result output section 104) determines whether or not the performance obtained by processing the actual image meets the switch condition (step S21). In the case where it is determined that the performance obtained by processing the actual image does not meet the switch condition (NO), the image processing apparatus 10 (evaluation result output section 104) ends the operation procedures. In the case where it is determined in step S21 that the switch condition is met (YES), the image processing apparatus 10 (performance evaluation section 103) re-evaluates the performance using the test image (step S22).

Next, the image processing apparatus 10 (actual process select section 105) selects a combination of processes, the evaluated performance of which meets the second selection condition determined in advance, from among the plurality of combinations of processes on the basis of the result of the evaluation in step S22 (step S23). Subsequently, the image processing apparatus 10 (process requesting section 102) requests the image-associated processing sections to execute the series of processes indicated in the selected combination (step S24). After step S24, the image processing apparatus 10 returns to step S21 and operates.

In the information processing system 1, as described above, a plurality of processes are combined with each other to be used on an image. The performance of the processes is evaluated on the basis of the result of processing the test image, and the combination with the highest evaluation is selected, for example.

### [2] Modifications

The exemplary embodiment discussed above is merely exemplary of the present disclosure, and may be modified as follows. The exemplary embodiment and modifications may be implemented in combination as necessary.

[2-1] Switch Condition

In the exemplary embodiment, the switch condition is met in the case where the performance obtained by processing the actual image does not meet a determined criterion. However, the present disclosure is not limited thereto. For example, the switch condition may be a condition that is met in the case where the rate of reduction from the performance evaluated with the test image to the performance obtained by processing the actual image is a threshold or more.

For the processing time, for example, the evaluation result output section 104 calculates (T2−T1)/T1 as the rate of reduction in the performance, for example, in the case where the performance is lowered with a processing time T2 with the actual image being longer than a processing time T1 with the test image. In this manner, the rate of reduction in the performance may be a value that becomes larger as the performance reduces. The evaluation result output section 104 determines that the switch condition is met in the case where the calculated rate of reduction is equal to or more than the threshold.

The switch condition may be a condition that is met in the case where the form of represented information is different between the test image and the actual image. For images including characters, for example, the form of information includes a font form and a handwritten form. The evaluation result output section 104 determines the form of the characters included in the test image and the actual image, and determines that the switch condition is met in the case where the determined forms are different from each other.

[2-2] Re-Evaluation

In the exemplary embodiment, the performance evaluation section 103 re-evaluates the performance using the test image in the case where the switch condition is met. However, the performance evaluation section 103 may re-evaluate the performance using the actual image, rather than the test image. In this case, in the case where the switch condition is met, the image-associated processing sections switch to the combination of processes, the performance of which meets the second selection condition, after re-evaluating the performance using the actual image.

The performance evaluation section 103 may re-evaluate the performance on the basis of the result of executing, on the actual image, processes included in a combination of processes that is different from the combination of processes that meets the first selection condition.

[2-3] Reuse of First Selection Condition

In the exemplary embodiment, the image-associated processing sections process the actual image after switching to a combination of processes, the evaluated performance of which meets the second selection condition, in the case where the switch condition is met. However, there may be a case where the switch condition is not met under the influence of a system failure etc., for example, after switching is made to the combination of processes, the performance of which meets the second selection condition.

In such a case, the image-associated processing sections may process the actual image after switching to a combination of processes, the performance of which meets the first selection condition. The determination as to whether the switch condition is not met may be made by the evaluation result output section 104 as in the exemplary embodiment. Even if the switch condition is met for a combination of processes, the performance of which meets the first selection condition, such a situation may be due to a temporary system error etc. and may be resolved as the time elapses.

In such a case, the switch condition is not met even if the combination of processes, the performance of which meets the first selection condition, is used again.

The evaluation result output section 104 may determine whether the switch condition is not met on the basis of the result of executing, on the actual image, processes included in a combination that is different from the combination of processes, the performance of which meets the second selection condition. The different combination of processes may be the combination of processes, the performance of which meets the first selection condition, or may be a combination of processes, the performance of which meets a selection condition that is different from the first selection condition and the second selection condition.

[2-4] Functional Configuration

The configuration of functions implemented by the information processing system 1 is not limited to that illustrated in FIG. 4. For example, while the evaluation result output section 104 of the image processing apparatus 10 outputs the evaluation result and determines whether or not the switch condition is met in the exemplary embodiment, such operations may be performed by separate functions.

In addition, the operations performed by the performance evaluation section 103 and the evaluation result output section 104 may be performed by a single function, for example. In addition, the functions implemented by the image processing apparatus 10 may be implemented by two or more information processing apparatuses or a computer resource provided by a cloud service. In short, the range of operation performed by each function and the device that implements each function may be determined freely as long as the functions indicated in FIG. 4 are implemented by the information processing system as a whole.

[2-5] Processor

In the embodiments above, the processor refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

[2-6] Category of the Disclosure

The present disclosure may also be grasped as an information processing system (exemplified by the information processing system 1) that includes an information processing apparatus, besides an information processing apparatus such as an image processing apparatus and an external processing apparatus. Alternatively, the present disclosure may also be grasped as an information processing method for implementing the processes performed by the information processing apparatus, or as a program for causing a computer that controls the information processing apparatus to function. The program may be provided in the form of a storage medium such as an optical disc that stores the program, downloaded to a computer via a communication line such as the Internet and installed to become usable, etc.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to
evaluate a performance of each of a plurality of combinations of processes, each combination including a series of processes, the plurality of combinations being included in a plurality of processes, the series of processes being configured to be performed on an image, the performance being evaluated on a basis of a result of performing the series of processes on a test image for each combination,
select a combination of processes, the evaluated performance of which meets a first selection condition, from among the plurality of combinations of processes, and process an actual image, and
in a case where a performance obtained by processing the actual image meets a switch condition determined in advance, switch to a combination of processes, the evaluated performance of which meets a second selection condition, and process the actual image.

2. The information processing apparatus according to claim 1,
wherein the switch condition is met in a case where the performance obtained by processing the actual image does not meet a determined criterion.

3. The information processing apparatus according to claim 1,
wherein the switch condition is met in a case where a form of represented information is different between the test image and the actual image.

4. The information processing apparatus according to claim 2,
wherein the switch condition is met in a case where a form of represented information is different between the test image and the actual image.

5. The information processing apparatus according to claim 1,
wherein the processor is configured to, in a case where the switch condition is met, switch to the combination of processes, the performance of which meets the second selection condition, after re-evaluating the performance obtained using the test image.

6. The information processing apparatus according to claim 2,
wherein the processor is configured to, in a case where the switch condition is met, switch to the combination of processes, the performance of which meets the second selection condition, after re-evaluating the performance obtained using the test image.

7. The information processing apparatus according to claim 3,
wherein the processor is configured to, in a case where the switch condition is met, switch to the combination of processes, the performance of which meets the second selection condition, after re-evaluating the performance obtained using the test image.

8. The information processing apparatus according to claim 4,
wherein the processor is configured to, in a case where the switch condition is met, switch to the combination of processes, the performance of which meets the second selection condition, after re-evaluating the performance obtained using the test image.

9. The information processing apparatus according to claim 1,
wherein the processor is configured to, in a case where the switch condition is met, switch to the combination of processes, the performance of which meets the second selection condition, after re-evaluating the performance obtained using the actual image.

10. The information processing apparatus according to claim 2,
wherein the processor is configured to, in a case where the switch condition is met, switch to the combination of processes, the performance of which meets the second selection condition, after re-evaluating the performance obtained using the actual image.

11. The information processing apparatus according to claim 3,
wherein the processor is configured to, in a case where the switch condition is met, switch to the combination of processes, the performance of which meets the second selection condition, after re-evaluating the performance obtained using the actual image.

12. The information processing apparatus according to claim 4,
wherein the processor is configured to, in a case where the switch condition is met, switch to the combination of processes, the performance of which meets the second selection condition, after re-evaluating the performance obtained using the actual image.

13. The information processing apparatus according to claim 9,
wherein the processor is configured to re-evaluate the performance obtained using the actual image on a basis of a result of executing, on the actual image, processes included in a combination that is different from the combination of processes, the performance of which meets the first selection condition.

14. The information processing apparatus according to claim 10,
wherein the processor is configured to re-evaluate the performance obtained using the actual image on a basis of a result of executing, on the actual image, processes included in a combination that is different from the combination of processes, the performance of which meets the first selection condition.

15. The information processing apparatus according to claim 11,
wherein the processor is configured to re-evaluate the performance obtained using the actual image on a basis of a result of executing, on the actual image, processes included in a combination that is different from the combination of processes, the performance of which meets the first selection condition.

16. The information processing apparatus according to claim 12,
wherein the processor is configured to re-evaluate the performance obtained using the actual image on a basis of a result of executing, on the actual image, processes included in a combination that is different from the combination of processes, the performance of which meets the first selection condition.

17. The information processing apparatus according to claim 1,
wherein the processor is configured to process the actual image after switching to the combination of processes, the performance of which meets the first selection condition, in a case where the switch condition is not met after switching is made to the combination of processes, the performance of which meets the second selection condition.

18. The information processing apparatus according to claim 2,
wherein the processor is configured to process the actual image after switching to the combination of processes, the performance of which meets the first selection condition, in a case where the switch condition is not met after switching is made to the combination of processes, the performance of which meets the second selection condition.

19. The information processing apparatus according to claim 3,
wherein the processor is configured to process the actual image after switching to the combination of processes, the performance of which meets the first selection condition, in a case where the switch condition is not met after switching is made to the combination of processes, the performance of which meets the second selection condition.

20. The information processing apparatus according to claim 17,
wherein the processor is configured to determine whether the switch condition is not met on a basis of a result of executing, on the actual image, processes included in a combination that is different from the combination of processes, the performance of which meets the second selection condition.
